(19) United States
(12) Patent Application Publication
(10) Pub. No.: US 2009/0080961 A1
(43) Pub. Date: Mar. 26, 2009

(54) PRINTING MACHINE

(75) Inventors: Satoshi MORIMOTO, Hiroshima (JP); Yoshiro Matsuura, Hiroshima (JP)

Correspondence Address: LOWE HAUPTMAN HAM & BERNER, LLP, 1700 DIAGONAL ROAD, SUITE 300, ALEXANDRIA, VA, 22314, US

(73) Assignee: MITSUBISHI HEAVY INDUSTRIES, LTD., TOKYO (JP)

(21) Appl. No.: 12/036,606

(22) Filed: Feb. 25, 2008

(30) Foreign Application Priority Data
Sep. 20, 2007 (JP) 2007-244517

(51) Int. Cl. B41J 29/02

(52) U.S. Cl. 400/693

(57) ABSTRACT

A printing press includes a printing unit, a feeder unit, and a delivery unit. At least one of the units is provided with a panel for either or both operating the unit and displaying the state of the unit. The panel is attached to the unit with a magnet, and is held by the attractive force of the magnet.

### BACKGROUND OF THE INVENTION

1. Field of the Invention

The present invention relates to a printing press.

2. Description of the Related Art

Printing machines developed in recent years include a printing unit equipped with an operation panel (hereinafter, “panel”) for controlling the printing unit.

Japanese Patent Application Laid-Open No. H11-291462 discloses a conventional technology related to such a printing press (gravure printing press). The printing press includes a plurality of printing units arranged at a predetermined interval. Each of the printing units includes a printing mechanism that includes a cylinder and various printing auxiliaries, and a control operation unit of the printing mechanism. In the printing press, the printing mechanism is arranged in such a manner that the longitudinal side of the printing mechanism is orthogonal to a direction of arrangement of the printing unit. The control operation unit is arranged on an end portion of the longitudinal side of the printing mechanism, and includes a panel having various operation switches. The panel is arranged on the surface of the control operation unit, which is inclined from a plane orthogonal to the longitudinal direction of the printing mechanism.

However, in the conventional technology, the panel is fixed to the printing unit with screws or nuts. Therefore, upon replacement of the panel, it is necessary to remove screws or the like. Therefore, the replacement of a panel is cumbersome and takes a long time.

### SUMMARY OF THE INVENTION

It is an object of the present invention to at least partially solve the problems in the conventional technology.

According to an aspect of the present invention, there is provided a printing press that includes a plurality of units including a printing unit, a feeder unit, and a delivery unit. At least one of the units includes a panel for at least operating the unit or displaying the state of the unit. The panel is attached to the unit with a magnet.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic diagram of a printing press according to an embodiment of the present invention;

FIGS. 2 to 7 are schematic diagrams for explaining a fixing structure for fixing a panel shown in FIG. 1;

FIG. 8 is a schematic diagram of a modification of the fixing structure;

FIG. 9 is a schematic diagram of another modification of the fixing structure;

FIGS. 10 and 11 are schematic diagrams of still another modification of the fixing structure; and

FIG. 12 is a schematic diagram of still another modification of the fixing structure.

### DETAILED DESCRIPTION OF THE PREFERRED EMBODIMENTS

Exemplary embodiments of the present invention are explained in detail below with reference to the accompanying drawings.

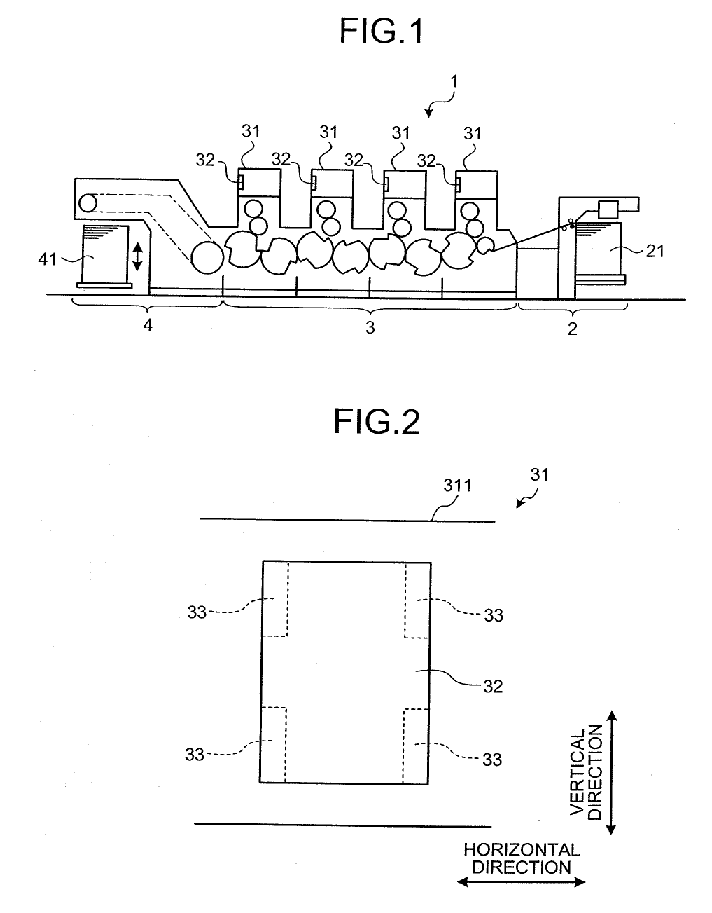

FIG. 1 is a schematic diagram of a printing press 1 according to an embodiment of the present invention. The printing press 1 is, for example, a sheet-fed printing press, and includes a feed mechanism 2, a printing mechanism 3, and a delivery mechanism 4 (see FIG. 1). The feed mechanism 2 includes a feeder unit 21. The feeder unit 21 picks up a sheet set for printing, and feeds the sheet to the printing mechanism 3. Specifically, a plurality of sheets are stacked and set in the feeder unit 21, and each of the sheets is sequentially picked up and fed to the printing mechanism 3. The printing mechanism 3 includes a plurality of the printing units 31. The printing units 31 correspond to four different colors of C (cyan), M (magenta), Y (yellow), and BL (black), respectively, and aligned along a path for conveying a sheet S. The printing mechanism 3 performs a color printing by causing the printing units 31 to sequentially perform offset printing on a sheet fed from the feed mechanism 2. The delivery mechanism 4 includes a delivery unit 41. The delivery unit 41 conveys a printed sheet obtained from the printing mechanism 3 to delivery the printed sheet.

The printing press 1 can include a coater unit (not shown) that performs coating on a sheet or other units (not shown) in addition to the feeder unit 21, the printing unit 31, and the delivery unit 41. The units to be added to the printing press 1 can be configured in the same manner as the units 21, 31, and 41.

The printing mechanism 3 includes a plurality of panels 32 as shown in FIG. 1. Examples of the panels 32 include an operation panel for controlling and operating the printing units 31, and a display panel for displaying the states of the printing units 31. The panels 32 are arranged on the printing units 31, respectively. Specifically, each of the panels 32 is arranged on an aisle side of a body portion 311 of each of the printing units 31.

Each of the panels 32 includes a substrate 321, a panel portion 322, and a panel sheet 323 as shown in FIG. 4. The substrate 321 is used for operating corresponding one of the printing units 31, and connected to the printing unit 31 via a cable 324. The substrate 321 includes a plurality of buttons or switches. The panel portion 322 is formed of a steel plate or the like, and forms a body of the panel 32. The panel portion 322 includes holes corresponding to switches on the substrate 321. The panel sheet 323 covers an operation screen (surface) of the panel 32. The panel 32 is formed of layers of the substrate 321, the panel portion 322, and the panel sheet 323. The panel 32 is in the form of a substantially square plate, and is arranged such that the panel sheet 323 faces an aisle side of the printing mechanism 3. A thickness “d” of the panel 32 is about 60 millimeters.

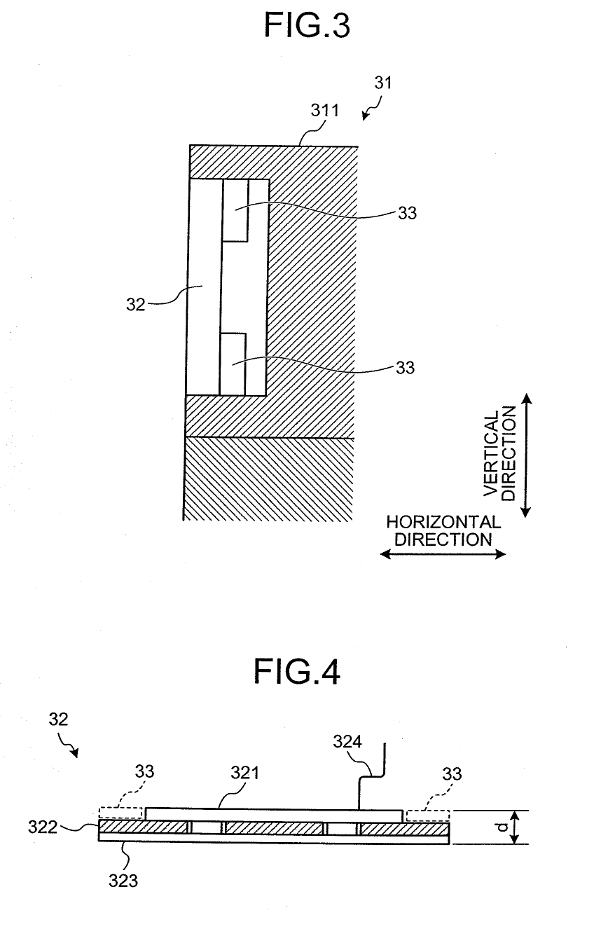

Each of the panels 32 is attached to each of the printing units 31 with magnets 33 as sown in FIGS. 2 and 3. Specifically, the panel 32 is held and fixed to the printing unit 31 by the attractive force of the magnets 33. In the embodiment, each of the panels 32 is attached to the body portion 311 of each of the printing units 31 with the four magnets 33.

While, in the embodiment, the panel 32 includes the substrate 321, the substrate 321 is not necessarily required. Specifically, the panel portion can include an operation buttons or is formed only of a display panel, and connected to a printing unit via a cable without a substrate.

As described above, the panel 32 is attached to the printing unit 31 with the magnets 33 by the attractive force thereof. Therefore, it is possible to easily replace the panel 32 (attach/remove the panel 32 to/from the printing unit 31) with less time. Moreover, a structure for fitting the panel 32 is simplified, which improves appearance of the printing unit 31.

On the other hand, if a panel is fixed to a printing unit by screws or nuts, such screws need to be removed upon replacement of the panel. Therefore, replacement of the panel is cumbersome, and takes a long time. Besides, such a screw may drop during the operation and damage other units. Moreover, such screws impair the appearance of a printing unit. Furthermore, it is difficult to remove dirt on a portion where a screw is arranged upon cleaning the panel, making it difficult to clean a printing press.

While, in the embodiment, the panel 32 is provided on the printing unit 31, a panel can be provided on the feeder unit 21 or the delivery unit 41.

Preferably, a concave portion 312 is formed in the printing unit 31, and the panel 32 is fitted in the concave portion 312 as shown in FIG. 6. That is, it is preferable that the panel 32 be held by the attractive force of the magnet 33 while fitted in the concave portion 312. With this configuration, the panel 32 can be stably set compared with a configuration where a panel is attached to a surface of a printing unit.

It is also preferable that a space “t” between the concave portion 312 and the panel 32 fitted in the concave portion 312 be equal to or smaller than one millimeter (see FIG. 7). If the space “t” between the concave portion 312 and the panel 32 is set to such a small value, the panel 32 is firmly fitted to the concave portion 312. Thus, the panel 32 can be stably held. Specifically, when the printing press 1 is in operation, it causes the printing unit 31 to vibrate. Therefore, if the space “t” is maintained in an appropriate range, it is possible to effectively prevent the panel 32 from coming off or being broken by the vibration.

Specifically, the panel 32 is in the form of a substantially square plate (see FIG. 4). The concave portion 312 is in substantially the same shape as the circumference of the panel 32 (see FIG. 6) so that the panel 32 is fitted in the concave portion 312. The space “t” between the circumference of the panel 32, which corresponds to the upper surface of the panel 32 in the vertical direction, and the inner surface of the concave portion 312 is set equal to or narrower than one millimeter (see FIG. 7). In addition, the bottom surface of the panel 32 is in contact with the inner surface of the concave portion 312. In this manner, the panel 32 is firmly fitted to the concave portion 312.

Preferably, the magnets 33 is arranged inside the concave portion 312 as shown in FIG. 6. That is, it is preferable that the magnets 33 be arranged inside the printing unit 31 (inside the concave portion 312) so that the panel 32 can be held by the attractive force of the magnets 33. With this, the magnets is not exposed to the outside of the printing unit. Thus, appearance of the printing unit can be improved.

Specifically, the four magnets 33 are attached to the inner surface of the concave portion 312 (see FIG. 6). The magnets 33 are in contact with the panel 32 in the concave portion 312, holding the panel 32 by the attractive force thereof. The magnets 33 are covered by the panel 32 not to be exposed to the outside of the printing unit 31.

Preferably, the front surface (operation surface) of the panel 32 is in the same plane as the surface of the printing unit 31 (see FIG. 3), or in the inner side from the surface of the printing unit 31 (not shown). Specifically, it is preferable that the panel 32 be embedded in the surface of the printing unit 31 so that a portion of the panel 32 does not protrude from the surface of the printing unit 31. With this configuration, the panel 32 is hardly considered as an obstacle. It is often the case that the panel 32 is arranged on an aisle side of the printing unit 31. Therefore, if a portion of the panel 32 protrudes from the surface of the printing unit 31, this portion may be an obstacle to those who passing the aisle.

According to the embodiment, the panel 32 is arranged in such a manner that the front surface of the panel 32 is in substantially the same plane as the surface of the printing unit 31 (the surface of the printing unit 31 is flat) as shown in FIG. 3. Accordingly, the panel 32 constitutes no obstacle to a person around the printing press 1. In addition, appearance of the printing press 1 is improved. Specifically, the panel 32 is held from the inner side of the printing unit 31 by the attractive force of the magnets 33 in the printing press 1. Therefore, it is easy to arrange the panel 32 in a flat manner as described above compared with a configuration where a panel is fixed by screws.

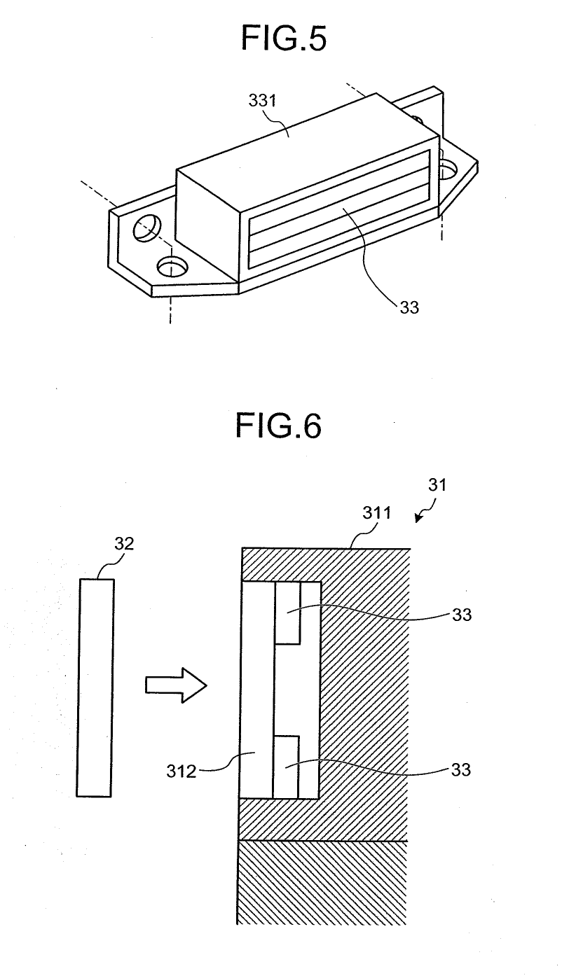

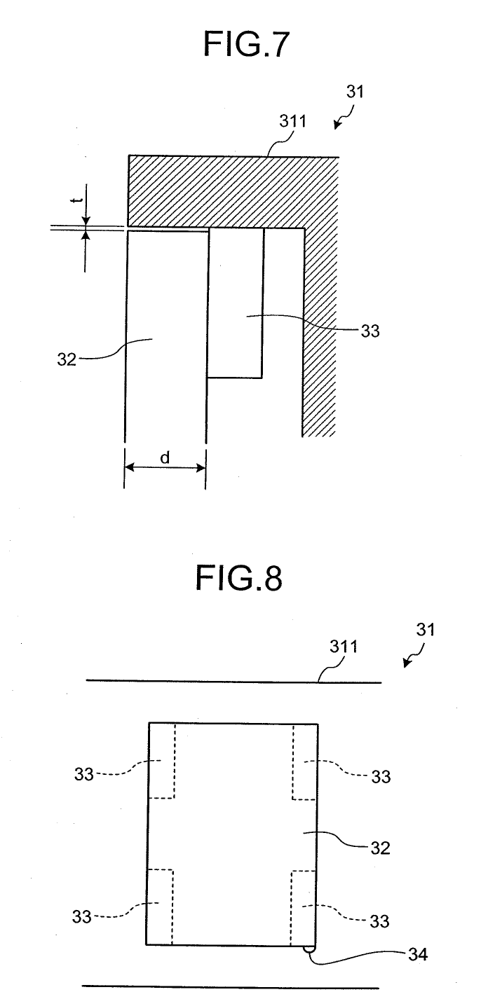

Preferably, a notched portion 34 for inserting tools is arranged on a fitted portion between the panel 32 and the concave portion 312 as shown in FIGS. 8 and 9. With this configuration, upon replacement of the panel 32, a tool (e.g., a flathead screwdriver) is inserted into the notched portion 34 to remove the panel 32 from the concave portion 312. Therefore, it is possible to facilitate the replacement of the panel 32. Because the panel 32 is fitted in the concave portion 312, and the front surface of the panel 32 is in the same plane as the surface of the printing unit 31 (see FIG. 3) or the front surface of the panel 32 is in the inner side from the surface of the printing unit 31 (not shown), it is difficult to remove the panel 32. If the notched portion 34 for inserting tools is arranged on the fitted portion between the panel 32 and the concave portion 312, the replacement of the panel 32 can be much easier.

Specifically, the front surface of the panel 32 is in the same plane as the surface of the printing unit 31, and the notched portion 34 is arranged at the corner of the concave portion 312 as shown in FIG. 8. The notched portion 34 can be arranged at a corner of the panel 32 as shown in FIG. 9. Upon replacement of the panel 32, a tool is inserted into the notched portion 34 to remove the panel 32.

Preferably, the magnets 33 are fixed on the printing unit 31 as shown in FIG. 6. Specifically, it is preferable that the magnets 33 be fixed on the printing unit 31 to hold the panel 32 by the attractive force thereof. With this configuration, the panel 32 can be removed from the printing unit 31 without removing other units. Consequently, the replacement of the panel 32 can be facilitated. Specifically, if the magnets 33 are fixed to the panel 32, the magnets are removed with the panel 32 from the printing unit 31. In such a case, the magnets 33 may pick up metal components around them, which interrupts the replacement work for the panel 32.

It is also preferable that the backside of the panel 32 adhere to the magnets 33 as shown in FIG. 3. With this configuration, when the panel 32 is set, the magnets 33 are not exposed from the front surface of the panel 32 (from the side of the panel sheet 323). As a result, appearance of the printing unit can be improved.

In the embodiment, the four magnets 33 are attached to the inner surface of the concave portion 312 (see FIG. 6). The panel 32 is held by the attractive force of the magnets 33. The positions of the magnets 33 and the panel 32 are determined so that the backside of the panel 32 adheres to the magnets 33 (see FIGS. 2 and 3). Specifically, the panel 32 includes the panel portion 322 made of steel, and the back end portions of the panel portion 322 adhere to the magnets 33 (see FIG. 4). As a result, the magnets 33 are not exposed to the outside of the printing unit 31 when the panel 32 is set.

Sides of the panel 32 (the circumference of the panel 32 viewed from the front surface side of the panel 32) can adhere to the magnets 33. With this configuration, the panel 32 can also be properly held by the magnets 33.

Preferably, the magnets 33 are fixed to the printing unit 31 by screws. With this, it is possible to stably fix the magnets 33 to the printing unit 31 in a simple manner.

In the embodiment, the magnets 33 are held in a magnet case 331 made of resin (see FIG. 5). The magnet case 331 is attached to the body portion 311 of the printing unit 31 by screws such that the magnets 33 are fixed to the body portion 311 (see FIGS. 3 and 6).

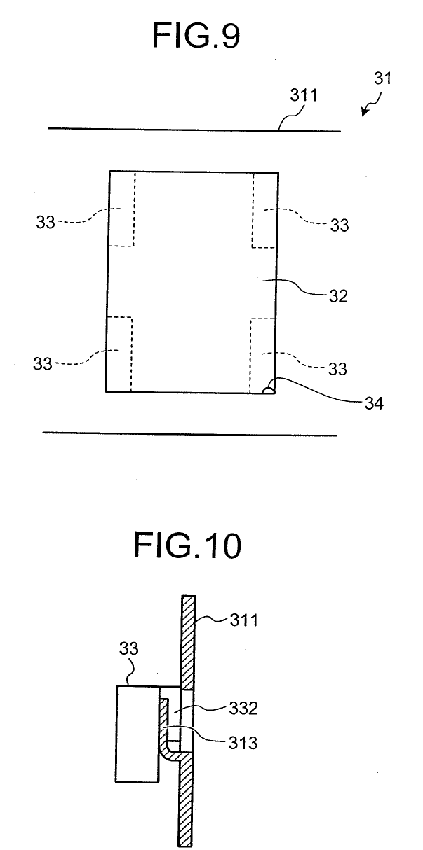

Alternatively, an engaging member 313 can be arranged on the printing unit 31 so that the magnets 33 engages the engaging member 313 to be fixed as shown in FIGS. 10 and 11. With this configuration, the magnets 33 can also be fixed to the printing unit 31 in a simple manner.

Specifically, in FIGS. 10 and 11, each of the magnets 33 includes a hook 332. The body portion 311 of the printing unit 31 is in the form of sheet metal, and the engaging member 313 in the form of a hook is formed on the body portion 311. The magnets 33 are fixed by the hook 332 that engages the engaging member 313. With this configuration, attachment of the magnets 33 can be simplified compared with a configuration where the magnets 33 are fixed with screws.

Preferably, the magnets 33 are permanent magnets. With such permanent magnets, it is possible to stably hold the panel 32 in a simple configuration with less cost. Specifically, if the magnets 33 are electromagnets, the panel 32 may come off when power outage occurs. If suckers (not shown) are used instead of the magnets 33, it is difficult to stably hold a panel for a long time.

Preferably, the magnets 33 are in an elongated shape, and their longitudinal sides are arranged along the vertical direction (see FIG. 2). With this configuration, the panel 32 can be effectively held in the vertical direction. Consequently, it is possible to stably hold the panel 32. Specifically, the printing unit 31 vibrates in the vertical direction when the printing press 1 is in operation. Therefore, by firmly holding the panel 32 in the vertical direction, it is possible to prevent the panel 32 from being coming off.

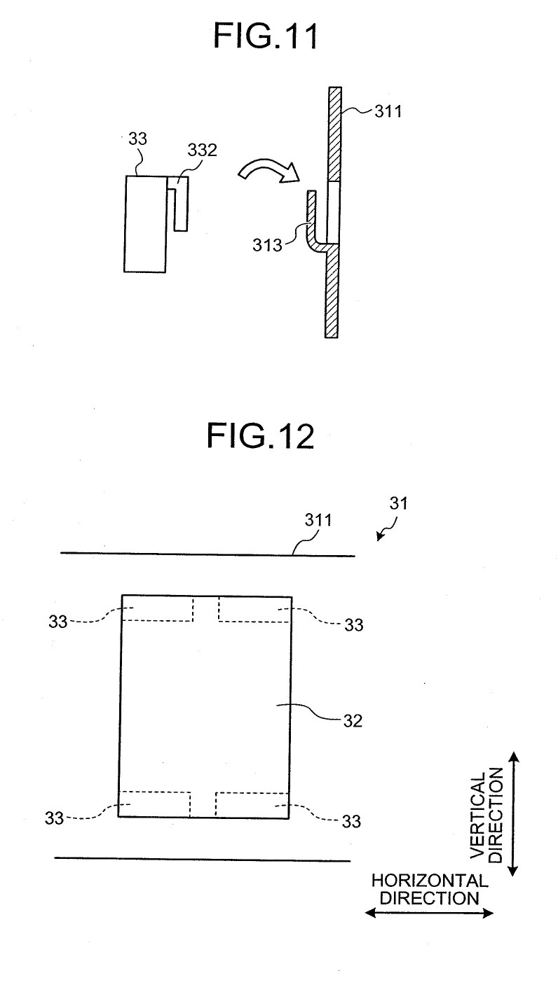

The magnets 33 can be arranged in such a manner that their longitudinal sides come along the horizontal direction as shown in FIG. 12. With this configuration, it is also possible to stably hold the panel 32.

While, in the embodiment, the four magnets 33 are arranged, the number of the magnets 33 is cited merely by way of example and without limitation. The strength of the magnets 33 can be changed as appropriate depending on the weight of the panel 32.

As set forth hereinabove, according to an embodiment of the present invention, a panel can be attached to a unit while stably held by the attractive force of a magnet with less cost, and can also be replaced in a simple manner.

Moreover, the magnet is arranged inside the unit and hardly viewed from the outside. Therefore, appearance of the unit can be improved.

Furthermore, the panel is embedded in a surface of the unit so that any portion of the panel does not protrude from the surface of the unit. Thus, the panel provides no obstacle to operation.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. A printing press that includes a plurality of units, the units including a printing unit, a feeder unit, and a delivery unit, wherein
at least one of the units includes a panel for at least operating the unit or displaying a state of the unit, and
the panel is attached to the unit with a magnet.

2. The printing press according to claim 1, wherein
the unit includes a concave portion, and
the panel is fitted to the concave portion.

3. The printing press according to claim 2, wherein a space between the concave portion and the panel fitted to the concave portion is equal to or less than one millimeter.

4. The printing press according to claim 2, wherein the magnet is arranged inside the concave portion.

5. The printing press according to claim 2, wherein a front surface of the panel is in substantially a same plane as a surface of the unit, or the front surface of the panel is recessed from the surface of the unit.

6. The printing press according to claim 2, wherein a notched portion for inserting a tool is arranged on a portion where the panel is fitted to the concave portion.

7. The printing press according to claim 1, wherein the magnet is fixed to the unit.

8. The printing press according to claim 7, wherein the panel is configured such that a back surface of the panel is attached to the magnet.

9. The printing press according to claim 7, wherein the magnet is fixed to the unit with a screw.

10. The printing press according to claim 8, wherein
an engaging member is arranged on the unit, and
the magnet is fixed by engaging the engaging member.

11. The printing press according to claim 9, wherein
an engaging member is arranged on the unit, and
the magnet is fixed by engaging the engaging member.

12. The printing press according to claim 1, wherein the magnet is a permanent magnet.

13. The printing press according to claim 1, wherein the magnet is in an elongated shape, and is arranged such that a longitudinal side of the magnet extends along a vertical direction.
